(19) United States
(12) Patent Application Publication
(10) Pub. No.: US 2010/0073383 A1
(43) Pub. Date: Mar. 25, 2010

(54) Cloth simulation pipeline

(76) Inventors: Sergey Sidorov, Vyazniki (RU); Anna Gorbunova, Nizhny Novdorod (RU)

Correspondence Address: TROP, PRUNER & HU, P.C., 1616 S. VOSS RD., SUITE 750, HOUSTON, TX, 77057-2631, US

(21) Appl. No.: 12/284,751

(22) Filed: Sep. 25, 2008

(51) Int. Cl. G06T 15/70

(52) U.S. Cl. 345/474

(57) ABSTRACT

A cloth simulation pipeline calculates normals between a cloth image and a colliding object image. The maximum value normal may be used to resolve the collision between the object and cloth images.

### BACKGROUND

This relates generally to cloth simulations and to computer systems that implement cloth simulations.

Cloth simulations produce the visual effect of real time cloth movement. In other words, the cloth simulator creates the appearance of cloth movement in response to forces that appear in the image to be applied to the cloth. As an example, as the user walks, the user's clothing may appear to move. The cloth simulator enables the image of the cloth to act in a realistic fashion in response to forces applied to the cloth.

Any deformable surface may also be simulated with a cloth simulation. For example, the deformation of a vehicle body during a collision may be simulated by a cloth simulation.

### BRIEF DESCRIPTION OF THE DRAWINGS

FIG. 1 is a mass-spring model in accordance with one embodiment;

FIG. 2 is a cloth simulation pipeline in accordance with one embodiment;

FIG. 3 is a schematic depiction of the interaction between cloth and an external object;

FIG. 4 is a sequence for collision resolution in accordance with one embodiment; and

FIG. 5 is a schematic depiction of one embodiment.

### DETAILED DESCRIPTION

In accordance with some embodiments, a cloth simulation pipeline may resolve an image of a collision with cloth by determining the best response normal. The cloth image may be broken up into a grid-like array of cloth particles that represent the image of the cloth. The response normal is the direction used for changing the velocity of a cloth particle in the case where the cloth particle collides with an image of a rigid object. The response normal is a normal to the surface of a triangle used to represent the rigid object image.

As used herein, the term “cloth” refers to an image of any deformable surface.

In the case of cloth colliding with an object that is represented as a set of triangles for graphic imaging purposes, every particle of the cloth can be thought of as colliding with different triangles on the object. Each object triangle surface has its own normal. In accordance with some embodiments, the normal that is chosen for collision resolution is the one that makes the biggest response and, thereby, prevents the appearance of object penetration through the cloth. The assumption of the cloth simulation is that the cloth is generally not penetrated and so in any collision, all the colliding objects move the cloth without penetrating it.

Since every particle on the cloth collides with several triangles representing an image of a rigid object, in the collision detection stage, a set of normals are determined and a normal is chosen for determining the cloth image's response to the collision. Selecting less than all the normals may reduce the computational complexity of the collision resolution. The best normal allows the biggest change in position for the particles away from the collided objects, while preventing penetration in a way that facilitates a faster algorithm in some embodiments.

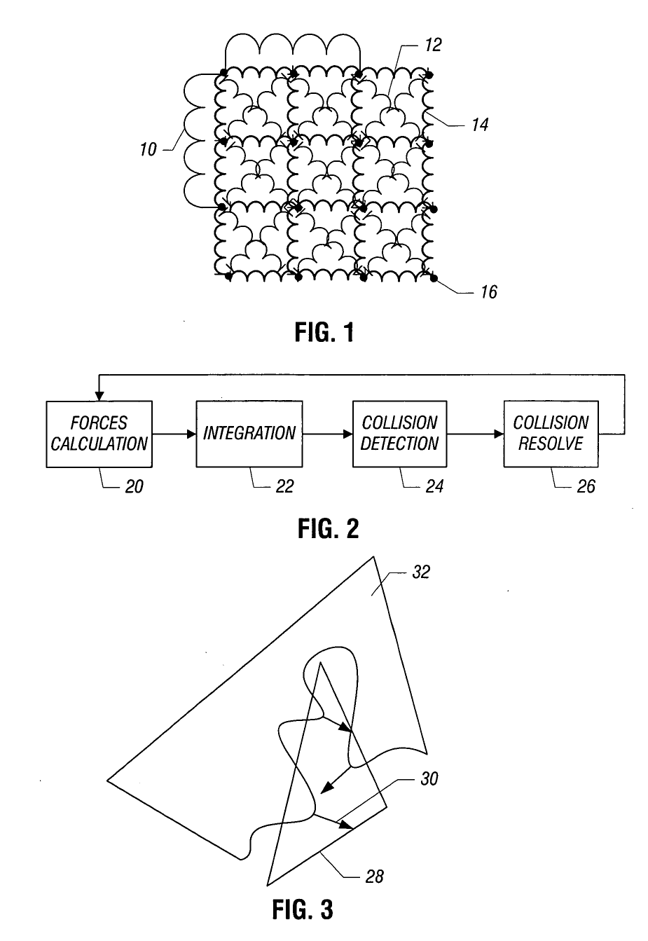

Referring to FIG. 1, cloth can be represented by a mass spring model. The mass spring model breaks the cloth down into particles 16 that are linked to their neighbors by massless springs 14. Internal forces within the cloth can be represented by tension within the springs 12 between neighbors. External forces, such as gravity, viscous damping, and the like can be represented by external springs 10. The mass spring model, represented mathematically, may then be used to simulate a force based approach that calculates the forces applied to cloth particles.

Thus, the cloth simulation, shown in FIG. 2, begins in block 20 by calculating the forces applied to the cloth. In an integration step, the interaction of external objects with the cloth is determined in a plurality of time-based steps. Multiple steps per frame may be used to achieve smooth cloth movement. Then, after the integration phase 22, the collision detection phase 24 detects collisions between objects and the cloth. The effect of those collisions is then resolved in the collision resolution stage 26.

Once the collision detection phase is completed, the correct response of the cloth to the collision may satisfy the constraints applied to the cloth. The best response normal is calculated. The best response normal is the one with the maximum response value at the force calculation stage of the cloth simulation.

The calculated maximum response value is used to update the velocities of the cloth triangles. Calculation of the response normal direction is important to correct collision resolution and the avoidance of penetration.

Referring to FIG. 3, the interaction between an external object 32 and a cloth triangle 28 is illustrated. The normals in the intersection areas are indicated by arrows 30. It can be seen in this example that there are three areas of intersection, each associated with a different normal indicated by an arrow 30. Thus, the arrow actually labeled 30 would appear to be the one that has the largest collision resolution and may, in some embodiments, be the one that is selected for further analysis.

Referring to FIG. 4, the collision resolution stage 26 may be implemented in software, hardware, or firmware. In the case of a software implementation, the sequence may be implemented in computer executable instructions stored on a computer readable medium. Computer readable media may include optical storage or any semiconductor memory.

For each cloth particle 16, the number of collisions between that particle and an external object is determined (block 40). If this number is greater than one, then it is necessary to select the best normal for the collision response calculation. The check at block 40 may determine whether there are any collisions with each particle of the cloth.

The distance between the cloth and the collided body is calculated for every applied normal, as indicated in block 42. After the collision response step, the position of the particle at the next instance of time is calculated using the current, and potentially, best response normal. The normal providing the largest collision resolution, which is the biggest distance between collided objects, is calculated for every cloth particle. Then the normal is chosen for which the computed distance is maximum, as indicated in block 44. This normal is then used to update the clock triangle velocity, as indicated in block 46.

The collision response algorithm can be represented by the following pseudocode:

```
For 1 to number of particles do
{
  Num = number of collisions (contact points) for current particle
  Bestnormal = normal[1];
  ResolveCollision(input:CurrentVelocity[1],  input:normal[1],
output:NewVelocity[1]);
  If(Num > 1)
  {
      For i = 2 to Num do
      {
      If(normal[i] != Bestnormal)
        Bestnormal = CheckForBestNormal(input:NewVelocity[i−1],
    input:normal[i], input: Bestnormal, input:CurrentVelocity[i]);
      }
  }
}
```

In some embodiments, a single instruction multiple data (SIMD) processor may be utilized to execute the cloth simulation. It may be able to do general purpose calculations, graphics processing, and provide sufficient computational capability.

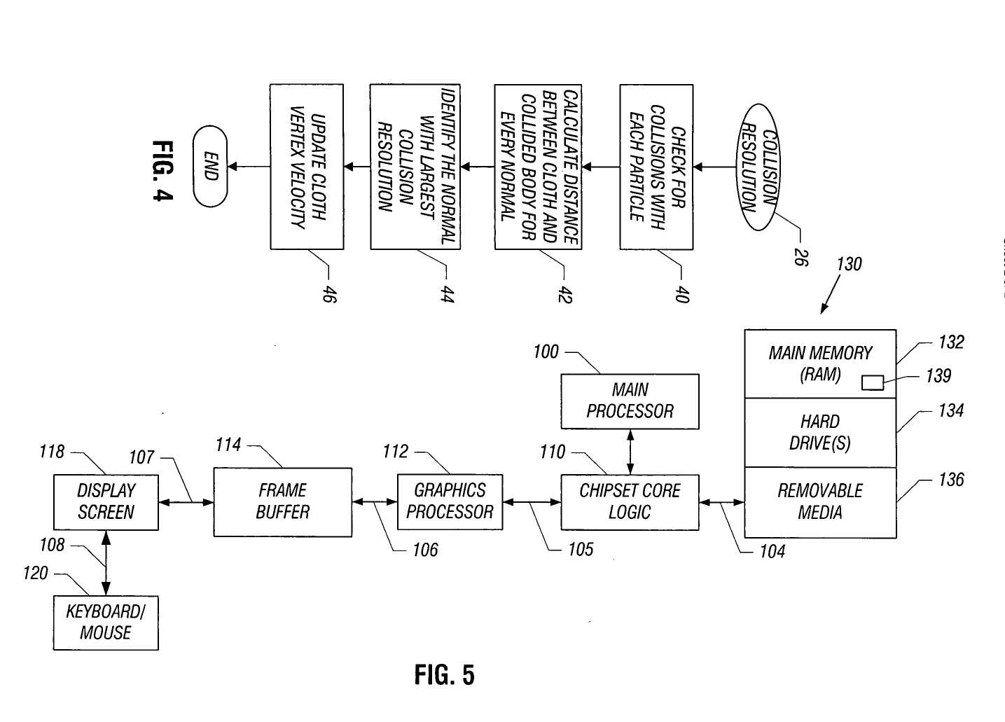

Referring to FIG. 5, a processor-based system 130 may include a graphics processor 112. In one embodiment, the graphics processor 112 is a symmetric multiprocessing (SMP) processor, a vector processor, or a single instruction multiple data processor using four way of sixteen way data sets. In one embodiment, the graphics processor 112 may implement the collision resolution 26, shown in FIG. 4. It may do so using software, in one embodiment. However, in other embodiments, hardware or combinations of hardware and software, such as firmware, may be utilized. The graphics processor 112 may, itself, store the instructions for implementing a software based sequence 26, such instructions stored in a computer readable medium within the processor 112 or in a storage device or memory device, coupled to the processor 112. For example, the storage may be the main memory 132 and a sequence of instructions may be stored in the storage area 139 therein.

The graphics processor may work with a main processor or central processing unit 100. It some embodiments that use software implementations, the software could also be implemented in the main processor 100. The graphics processor 112 and the main processor 100, in one embodiment, may be coupled by a bus 105 and the chipset core logic 110. The chipset core logic also interfaces with various storage, including the removable media 136, hard drives 134, and main memory 132.

The graphics pipeline includes not only the graphics processor 112, but also a frame buffer 114. The frame buffer 114 may be coupled through buses 106 and 107. A display screen 118 may be controlled by a bus 108 by a keyboard or mouse 120, in some embodiments.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining normals between an external object image colliding with a cloth image;
identifying a normal having maximum value; and
using said maximum value normal to resolve a collision between the object image and the cloth image.

2. The method of claim 1 including dividing the cloth image into particles and checking for collisions between each cloth particle and the object.

3. The method of claim 2 including calculating a distance between the cloth image and the external object image for every normal.

4. The method of claim 3 including identifying a normal with the largest collision resolution.

5. The method of claim 4 including updating a cloth triangle velocity using only said maximum value normal.

6. The method of claim 1 including resolving a collision using a single instruction multiple data processor.

7. An apparatus comprising:
a chipset core logic; and
a processor coupled to said core logic, said processor to identify a normal having a maximum value between an image of an external object and a cloth image and use said maximum value normal to update the movement of said cloth in response to said collision.

8. The apparatus of claim 7 wherein said processor is a single instruction multiple data processor.

9. The apparatus of claim 7, said processor to divide a cloth image into particles and to check for collisions between each cloth particle and triangles representing said object.

10. The apparatus of claim 9, said processor to calculate a distance between the cloth image and the external object image for every normal.

11. The apparatus of claim 10, said processor to identify a normal with the largest collision resolution.

12. The apparatus of claim 11, said processor to update a cloth triangle velocity using only said maximum value normal.

13. The apparatus of claim 11 wherein said processor to use a mass spring representation of the cloth image to analyze collisions with said cloth image.

14. The apparatus of claim 7 wherein said processor is a graphics processor further including a general purpose processor coupled to said graphics processor.

15. The apparatus of claim 7 wherein said processor is a multi-core processor.
